(19) United States
(12) Patent Application Publication
(10) Pub. No.: US 2007/0245908 A1
(43) Pub. Date: Oct. 25, 2007

(54) FRUIT JUICE EXTRACTOR INCLUDING PEEL OIL AND FRIT SEPARATION FILTER AND ASSOCIATED METHODS

(76) Inventors: Helio Brandao, Lakeland, FL (US); John Freer, Lakeland, FL (US); Steven C. Keller, Howey-in-the-hills, FL (US); Juzar Lokhandwala, Temple Terrace, FL (US); Gary Merritt, Winter Haven, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/379,525

(22) Filed: Apr. 20, 2006

(51) Int. Cl. B30B 9/02

(52) U.S. Cl. 100/213

(57) ABSTRACT

A fruit juice extractor may include at least one fruit juice extracting assembly for extracting fruit juice and generating a discharge comprising peel oil and frit, and a discharge separation filter positioned below a misfed fruit guide and having a proximal end adjacent the at least one fruit juice extracting assembly and a distal end opposite the proximal end. The discharge separation filter may have a porosity to permit passage therethrough of peel oil while separating the frit, and the discharge separation filter may be positioned at an inclined angle from horizontal so that the distal end thereof sheds frit separated from the discharge. The discharge separation filter permits the peel oil and frit to be separated near the fruit juice extractor assembly instead of downstream therefrom.

### FIELD OF THE INVENTION

The present invention relates to the field of juice extraction, and, more particularly, to the separation of peel oil and frit from a discharge of a fruit juice extractor and related methods.

### BACKGROUND OF THE INVENTION

Citrus fruit juice extraction on a commercial scale can be advantageously performed with a juice extractor including upper and lower cups that move relative to one another along a reciprocal path of travel. The sides of both the upper and lower cups typically comprise fingers that support a fruit so that it can be squeezed without bursting. The fingers of the upper cup interdigitate or intermesh with those of the lower cup. An orange or other fruit can be fed, for example, to the bottom cup by a cam-operated feeding device. The upper and lower cups are brought together so that the respective fingers of the cup intermesh and the fruit therebetween is accordingly squeezed. Sharp, typically circular, cutters are positioned in the top and bottom cups. As the cups move relative to one another, the fruit is pressed against the cutters. The cutters cut plugs from both the top and bottom portions of the fruit as the interdigitating fingers of the two cups mesh together.

The cutting of the plug from the top portion of the fruit promotes separation of the peel from the internal portions of the fruit (i.e., juice and pulp). The plug cut from the lower portion of the fruit allows the internal portions of the fruit to be forced down into a strainer tube positioned just below the lower cup cutter. The strainer tube, in turn, is positioned within a manifold. Such whole fruit juice extraction is disclosed in commonly assigned U.S. Pat. Nos. 2,649,730; 2,780,988; 5,970,861; 5,992,311; 5,996, 485; and 6,568,319, for example, the contents of which are hereby incorporated by reference in their entirety.

Significant improvements in this fundamental juice extraction technology are described in commonly assigned Published U.S. Patent Application Nos. 2006/0037498; 2006/0037495; 2006/0037494; 2006/0037493; 2006/0037492; 2006/0037491; 2006/0037488, the contents of which are also incorporated herein by reference in their entirety. Among the improvements disclosed are pop-up nozzles for delivering recycle water to the lower extractor cups to remove peel oil and frit generated by the extraction process. Frit is defines as small pieces of fruit peel. In citrus fruit, for example, frit comprises pieces of flavedo and albedo, typically 0.5 to 10 mm in diameter. Water may also be applied to the fruit during juice extraction by use of a spray ring as disclosed in commonly assigned U.S. Pat. No. 3,717,084. The application of water to the external surface of the fruit during extraction aids in the recovery of peel oil.

Whether created by a spray ring, and/or pop-up or fixed water nozzles, this discharge of peel oil, frit and water is typically collected and carried away from the extractor for subsequent separation to recover the peel oil. Unfortunately, the water/peel oil/frit emulsion of the discharge will detrimentally experience water and peel oil absorption into the frit during the relatively long dwell time from its creation at the extractor to further downstream separation, such as through the use of a screw finisher, paddle finisher, or vibrating screen. This tends to make peel oil recovery more difficult.

One prior experimental attempt to address the long dwell time of the discharge used a screen on a portion of a misfed fruit guide. The misted fruit guide includes a series of spaced bars extending and sloping away from the extractor cups. As the name implies, the misfed fruit guide directs occasionally misted fruit away from the extractor to be discarded or joined back with the feed fruit. The screen was intended to pass the water and peel oil therethrough and collect the frit. Unfortunately, due to its construction and positioning on the misfed fruit guide, the frit tended to become dry and build-up before releasing in larger clumps. Misfed fruit would also contact the screen and tend to drive the frit into the screen thereby clogging the screen more quickly.

### SUMMARY OF THE INVENTION

In view of the foregoing background, it is therefore an object of the present invention to provide a fruit juice extractor and associated method for providing enhanced separation of the peel oil from the frit.

This and other objects, features and advantages in accordance with the invention are provided by a fruit juice extractor comprising at least one fruit juice extracting assembly for extracting fruit juice and generating a discharge comprising peel oil and frit, and a discharge separation filter positioned below a misfed fruit guide and having a proximal end adjacent the at least one fruit juice extracting assembly and a distal end opposite the proximal end. Moreover, the discharge separation filter may have a porosity to permit passage therethrough of peel oil while separating the frit, and the discharge separation filter may be positioned at an inclined angle from horizontal so that the distal end thereof sheds frit separated from the discharge. The discharge separation filter permits the peel oil and frit to be separated near the fruit juice extractor assembly instead of downstream therefrom. Accordingly, the efficiency of separation may be increased since the peel oil and frit do not remain in extended contact as in some of the contrasting prior art approaches. The positioning of the discharge separation filter beneath the misted fruit guide is also advantageous as it keeps the misfed fruit from driving the frit into the filter causing its premature clogging.

The discharge separation filter may be inclined at an angle from horizontal sufficient to shed the frit via gravity from the distal end of the discharge separation filter. In other words, in these embodiments, no vibration may be needed to encourage shedding of the frit. For example, the inclined angle from horizontal may be in a range of about 15° to 50°, and, more preferably, in a range of about 30° to 45°.

Another advantageous aspect of the discharge separation filter is that it may comprise a drip edge member adjacent the distal end thereof. The drip edge may capture and direct peel oil efficiently into a peel oil collection tank below the discharge separation filter. Considered in other terms, the peel oil collection tank may be positioned to collect peel oil passing through the discharge separation filter and dripping from the drip edge member.

The extractor may further include at least one water spray nozzle adding water to the discharge either continuously and/or at periodic cleaning intervals.

Accordingly, the discharge may also typically include water, and the water and peel oil emulsion may readily pass through the discharge separation filter for further processing.

The discharge separation filter may comprise a plurality of spaced apart frame members extending between the proximal and distal ends of the discharge separation filter, and a plurality of spaced apart filter members extending transverse to the frame members and carried thereby. In addition, each of the filter members may have a triangular cross-sectional shape with a base thereof defining an uppermost surface. This configuration may provide better filtering action with less likelihood of clogging.

The extractor may further comprise a frit collector positioned to collect frit shed from the distal end of the discharge separation filter. The extractor may also include a selectively operable guide chute adjacent the distal end of the discharge separation filter.

The misfed fruit guide may comprise a plurality of spaced apart inclined bars having respective proximal ends adjacent the at least one fruit juice extracting assembly and having respective distal ends opposite the proximal ends. In addition, the at least one fruit juice extractor may comprise at least one pair of reciprocating extraction cups, for example.

A method aspect is directed to separating peel oil from frit in a discharge from a fruit juice extractor. The fruit juice extractor may include at least one fruit juice extracting assembly for extracting fruit juice from fruit and generating the discharge comprising peel oil and frit, and a misfed fruit guide for guiding misfed fruit away from the at least one fruit juice extracting assembly. The method may comprise providing a discharge separation filter having a porosity to permit passage therethrough of peel oil while separating the frit, and positioning the discharge separation filter below the misfed fruit guide and at an inclined angle from horizontal so that peel oil passes through the discharge separation filter and so that a distal end of the discharge separation filter sheds frit separated from the discharge.

### BRIEF DESCRIPTION OF THE DRAWINGS

FIG. 1 is a schematic side elevation view of a fruit juice extractor and including a discharge separation filter according to the invention.

FIG. 2 is a rear perspective view of a portion of the fruit extractor as shown in FIG. 1 illustrating the misfed fruit guide and the discharge separation filter.

FIG. 3 is a greatly enlarged schematic cross-sectional view of a distal end portion of the discharge separation filter as shown in FIG. 1.

FIG. 4 is a bottom plan view of a portion of the discharge separation filter as shown in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer, to like elements throughout.

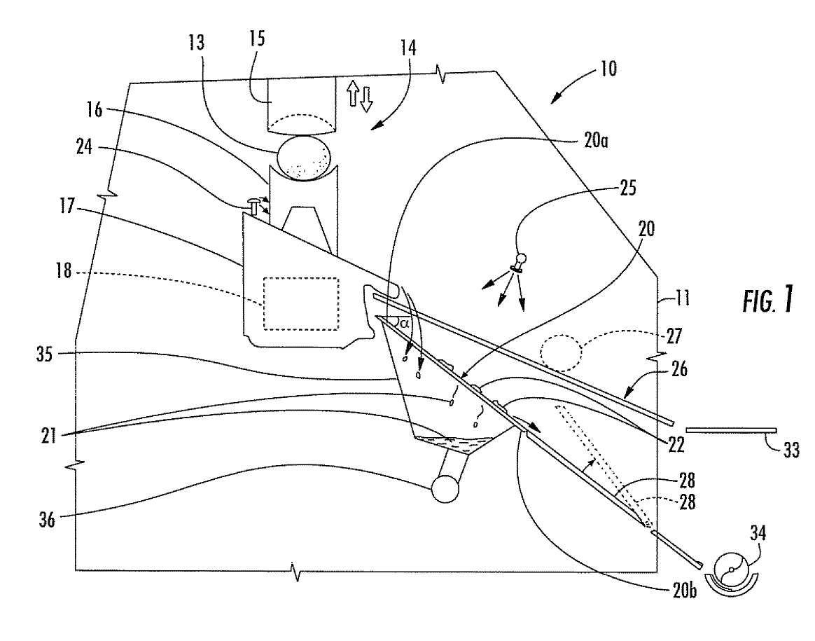

Referring initially to FIG. 1, the basic components of a fruit juice extractor 10 according to the invention are now described. The extractor 10 illustratively includes a housing 11 surrounding a plurality of fruit juice extracting assemblies 14, only one of which is shown for clarity of explanation. The fruit juice extracting assembly 14 is fed fruit 13 sequentially by a feeder, not shown, as will be appreciated by those skilled in the art. In the illustrated embodiment, the fruit juice extracting assembly 14 includes a reciprocating upper cup 15 and a fixed lower cup 16 carried by a bridge 17 the operation of which will also be readily appreciated by those skilled in the art. The bridge 17 houses an internal juice manifold 18. Further details regarding the juice extraction process can be found in the above mentioned U.S. patents and Published patent applications assigned to the assignee of the present invention. These details need no further discussion herein.

The fruit juice extracting assembly 14 also generates a discharge comprising peel oil 21 and frit 22. A series of recycle water nozzles 24 typically provide a flow of water to collect the peel oil 21 and capture and carry away the frit 22 generated during the juice extraction. Cleaning nozzles 25 spaced from the extraction assembly 14 may also be provided for periodic cleaning of the underlying components and may also add water to the discharge. Accordingly, the peel oil 21 and frit 22 discharge also typically includes water.

As noted herein, it is typically desired to separate the peel oil 21 from the frit 22. The water may be removed from the peel oil via a downstream finishing process as will be appreciated by those skilled in the art. However, the relatively long dwell times of prior art extractors typically allow the peel oil 21 (and water) to be absorbed back into the frit 22. To overcome this prior art drawback, the fruit juice extractor 10 includes a discharge separation filter 20 positioned below a misfed fruit guide 26 and having a proximal end 20a adjacent the fruit juice extracting assembly 14 and a distal end 20b opposite the proximal end. The misfed fruit guide 26 directs occasionally misfed fruit 27 away from the extraction assembly 14. The discharge separation filter 20 may have a porosity to permit passage therethrough of peel oil 21 (and water) while separating the frit 22. As shown in the illustrated embodiment, the discharge separation filter 20 may be preferably positioned at an inclined angle α from horizontal so that the distal end 20b sheds frit 22 separated from the discharge.

A first conveyor, such as in the form of the illustrated belt conveyor 33, is positioned at the distal end of the misfed fruit guide 26 to collect and carry away the misfed fruit. Similarly, a second conveyor, such as in the form of the illustrated screw conveyor 34, is positioned to collect the frit and carry it away from the extractor for further processing. Of course, other types of conveyors may be used as will be appreciated by those skilled in the art.

A peel oil (and water) collection tank 35 is positioned below the discharge separation filter 20 to collect the peel oil (and water) 21. The peel oil (and water) 21 is emptied from the tank 35 via the illustrated conduit 36 for further processing.

A selectively operable guide chute 28 is illustratively positioned downstream from the distal end 20b of the discharge separation filter 20. The selectively operable guide chute 28 may be useful for redirecting the frit to an alternative location as will be appreciated by those skilled in the art.

The discharge separation filter 20 permits the peel oil 21 and frit 22 to be separated near the fruit juice extractor assembly 14 instead of downstream therefrom as typically done in the prior art extractors. The efficiency of separation may be increased since the peel oil and frit do not remain in extended contact. The positioning of the discharge separation filter 20 beneath the misfed fruit guide 26 is also advantageous as it keeps the misfed fruit from driving the frit into and clogging the filter, such as would be the case if the misfed fruit guide were combined with the filter, for example. Cleaning is also simplified in the arrangement positioning the discharge separation filter 20 beneath the misfed fruit guide 26.

The discharge separation filter 20 may be inclined at an angle α from horizontal sufficient to shed the frit 22 via gravity from the distal end 20b of the discharge separation filter. Accordingly, in many embodiments no vibration may be needed to encourage shedding of the frit 22. For example, the inclined angle α may be in a range of about 15° to 50°, and, more preferably, in a range of about 30° to 45°.

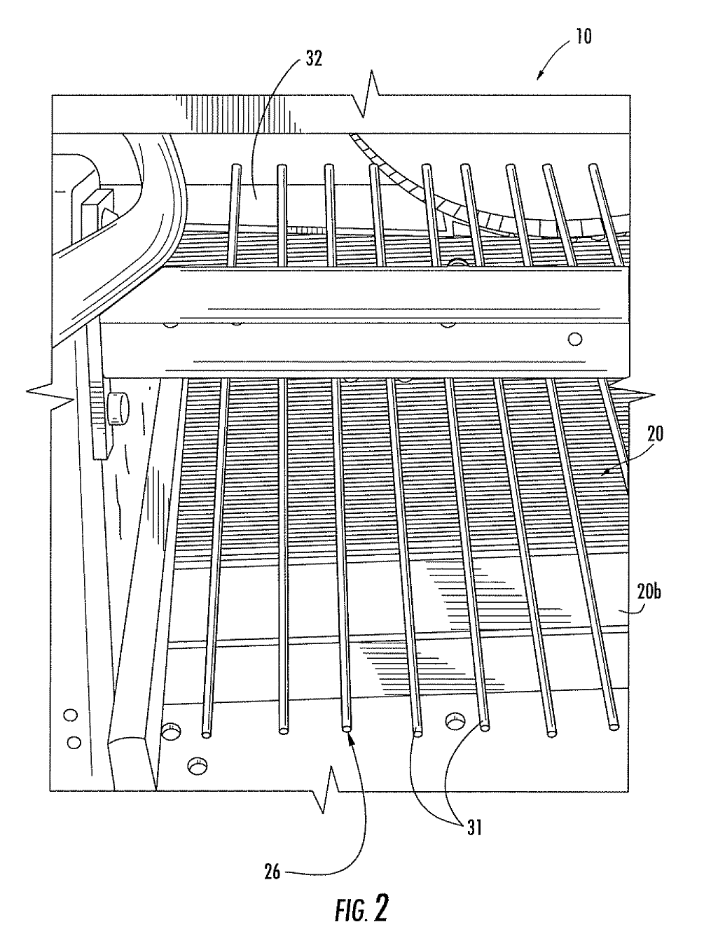

Referring now additionally to FIG. 2, the misfed fruit guide 26 illustratively includes a plurality of spaced apart inclined bars 31 having respective proximal ends adjacent the at least one fruit juice extracting assembly 14 and having respective distal ends opposite the proximal ends. The proximal ends of the inclined bars 31 are illustratively held in position by welding to a lateral base frame member 32 although other configurations are also possible. The discharge separation filter 20 is seen in FIG. 2 below the misfed fruit guide 26.

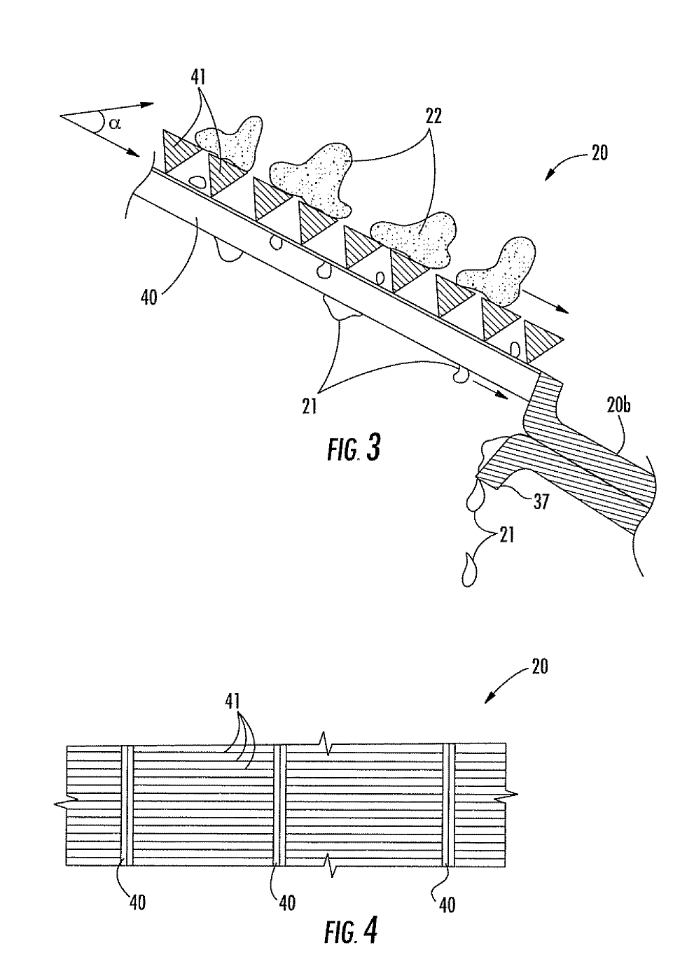

Referring now additionally to FIGS. 3 and 4 various features of the discharge separation filter 20 are now described. The discharge separation filter 20 comprises a plurality of spaced apart frame members 40 extending between the proximal and distal ends of the discharge separation filter, and a plurality of spaced apart filter members 41 extending transverse to the frame members and carried thereby. In the illustrated embodiment, each of the filter members 41 is the form of a wire having a triangular cross-sectional shape, or a vee-shape, with a base thereof defining an uppermost surface. This type of filter is commonly referred to as a Johnson Screen™ available from Johnson Screens of Australia. As will be appreciated by those of skill in the art, this configuration may provide better filtering action with less likelihood of clogging.

The discharge separation filter 20 illustratively includes a drip edge member 37 (FIG. 3) adjacent the distal end 20b thereof. The drip edge member 37 captures and direct peel oil 21 efficiently into the peel oil collection tank 35 below the discharge separation filter 20. The drip edge 37 is illustratively formed by a sheet of metal being attached at an upper end to the frame members 40, extending outwardly to the end tip of the discharge filter, and being folded upon itself to return with a free end shaped to provide the drip edge. As will be appreciated by those skilled in the art, many other configurations for the drip edge are contemplated and may be used in the extractor 10.

A method aspect is for separating peel oil 21 from frit 22 in the discharge from the fruit juice extractor 10 as described above and comprising at least one fruit juice extracting assembly 14 for extracting fruit juice from fruit 13 and generating the discharge, and the misfed fruit guide 26 for guiding misfed fruit 27 away from the fruit juice extracting assembly. The method may include providing a discharge separation filter 20 having a porosity to permit passage therethrough of peel oil 21 while separating the frit 22, and positioning the discharge separation filter below the misfed fruit guide 26 and at an inclined angle from horizontal so that peel oil passes through the discharge separation filter and so that a distal end of the discharge separation filter sheds frit separated from the discharge.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A fruit juice extractor comprising:
at least one fruit juice extracting assembly for extracting fruit juice and generating a discharge comprising peel oil and frit;
a misfed fruit guide for guiding misfed fruit away from said at least one fruit juice extracting assembly; and
a discharge separation filter positioned below said misfed fruit guide and having a proximal end adjacent said at least one fruit juice extracting assembly and a distal end opposite the proximal end;
said discharge separation filter having a porosity to permit passage therethrough of peel oil while separating the frit;
said discharge separation filter further being positioned at an inclined angle from horizontal so that the distal end thereof sheds frit separated from the discharge.

2. The fruit juice extractor according to claim 1 wherein the inclined angle from horizontal is sufficient to shed the frit via gravity from the distal end of said discharge separation filter.

3. The fruit juice extractor according to claim 2 wherein the inclined angle from horizontal is in a range of about 15° to 50°.

4. The fruit juice extractor according to claim 1 wherein said discharge separation filter comprises a drip edge member adjacent the distal end thereof.

5. The fruit juice extractor according to claim 4 further comprising a peel oil collection tank below said discharge separation filter positioned to collect peel oil passing through said discharge separation filter and dripping from said drip edge member.

6. The fruit juice extractor according to claim 1 further comprising at least one water spray nozzle adding water to the discharge.

7. The fruit juice extractor according to claim 1 wherein said discharge separation filter comprises:
a plurality of spaced apart frame members extending between the proximal and distal ends of said discharge separation filter; and
a plurality of spaced apart filter members extending transverse to said frame members and carried thereby.

8. The fruit juice extractor according to claim 7 wherein each of said filter members has a triangular cross-sectional shape with a base thereof defining an uppermost surface.

9. The fruit juice extractor according to claim 1 further comprising a frit collector positioned to collect frit shed from the distal end of said discharge separation filter.

10. The fruit juice extractor according to claim 1 further comprising a selectively operable guide chute adjacent the distal end of said discharge separation filter.

11. The fruit juice extractor according to claim 1 wherein said misfed fruit guide comprises a plurality of spaced apart inclined bars having respective proximal ends adjacent said at least one fruit juice extracting assembly and having respective distal ends opposite the proximal ends.

12. The fruit juice extractor according to claim 1 wherein said at least one fruit juice extractor comprises at least one pair of reciprocating extraction cups.

13. A fruit juice extractor comprising:
at least one fruit juice extracting assembly for extracting fruit juice and generating a discharge comprising peel oil and frit;
a discharge separation filter positioned having a proximal end adjacent said at least one fruit juice extracting assembly and a distal end opposite the proximal end;
said discharge separation filter having a porosity to permit passage therethrough of peel oil while separating the frit;
said discharge separation filter further being positioned at an inclined angle from horizontal so that the distal end thereof sheds frit separated from the discharge;
said discharge separation filter comprising a drip edge member adjacent the distal end thereof; and
a peel oil collection tank below said discharge separation filter positioned to collect peel oil passing through said discharge separation filter and dripping from said drip edge member.

14. The fruit juice extractor according to claim 13 wherein the inclined angle from horizontal is sufficient to shed the frit via gravity from the distal end of said discharge separation filter.

15. The fruit juice extractor according to claim 14 wherein the inclined angle from horizontal is in a range of about 15° to 50°.

16. The fruit juice extractor according to claim 13 further comprising at least one water spray nozzle adding water to the discharge.

17. The fruit juice extractor according to claim 13 wherein said discharge separation filter comprises:
a plurality of spaced apart frame members extending between the proximal and distal ends of said discharge separation filter; and
a plurality of spaced apart filter members extending transverse to said frame members and carried thereby.

18. The fruit juice extractor according to claim 13 further comprising a frit collector positioned to collect frit shed from the distal end of said discharge separation filter.

19. The fruit juice extractor according to claim 13 further comprising a misfed fruit guide above said discharge separation filter and comprising a plurality of spaced apart inclined bars having respective proximal ends adjacent said at least one fruit juice extracting assembly and having respective distal ends opposite the proximal ends.

20. A method of separating peel oil from frit in a discharge from a fruit juice extractor comprising at least one fruit juice extracting assembly for extracting fruit juice from fruit and generating the discharge comprising peel oil and frit, and a misfed fruit guide for guiding misfed fruit away from the at least one fruit juice extracting assembly, the method comprising:
providing a discharge separation filter having a porosity to permit passage therethrough of peel oil while separating the frit; and
positioning the discharge separation filter below the misfed fruit guide and at an inclined angle from horizontal so that peel oil passes through the discharge separation filter and so that a distal end of the discharge separation filter sheds frit separated from the discharge.

21. The method according to claim 20 wherein the inclined angle from horizontal is sufficient to shed the frit via gravity from the distal end of the discharge separation filter.

22. The method according to claim 21 wherein the inclined angle from horizontal is in a range of about 15° to 50°.

23. The method according to claim 20 wherein the discharge separation filter comprises a drip edge member adjacent the distal end thereof.

24. The method according to claim 23 further comprising using a peel oil collection tank below the discharge separation filter to collect peel oil passing through the discharge separation filter and dripping from the drip edge member.

25. The method according to claim 20 further comprising using at least one water spray nozzle to direct a water spray onto the misfed fruit guide and the discharge separation filter.

26. The method according to claim 20 wherein the discharge separation filter comprises:
a plurality of spaced apart frame members extending between the proximal and distal ends of the discharge separation filter; and
a plurality of spaced apart filter members extending transverse to the frame members and carried thereby.

27. The method according to claim 20 wherein the misfed fruit guide comprises a plurality of spaced apart inclined bars having respective proximal ends adjacent the at least one fruit juice extracting assembly and having respective distal ends opposite the proximal ends.
